(19) United States
(12) Patent Application Publication
(10) Pub. No.: US 2023/0151567 A1
(43) Pub. Date: May 18, 2023

(54) SYSTEM AND METHOD FOR ONCOMING TRAFFIC WARNING AT A WORK ZONE

(71) Applicant: SITE 2020 INCORPORATED, Dartmouth (CA)

(72) Inventor: Mitchell Alexander HOLLOHAN, Dartmouth (CA)

(21) Appl. No.: 17/987,326

(22) Filed: Nov. 15, 2022

Related U.S. Application Data
(60) Provisional application No. 63/279,712, filed on Nov. 16, 2021.

(51) Int. Cl. E01F 9/608; E01F 9/654; E01F 9/615; G08B 7/06; H04W 4/90; G01S 17/58

(52) U.S. Cl. CPC E01F 9/608; E01F 9/654; E01F 9/617; G08B 7/06; H04W 4/90; G01S 17/58

(57) ABSTRACT

A system and method are set forth for traffic warning at a road construction work zone, comprising at least one a motion sensor associated with at least one traffic cone proximate the road construction work zone for transmitting laser pulses in a direction of oncoming traffic and detecting reflected laser pulses from the oncoming traffic and in response transmitting an alert signal, and a portable alert unit for receiving the alert signal and generating a warning of the oncoming traffic

### FIELD

The present specification relates generally to traffic safety in a road construction work zone, and more particularly to a system and method for traffic warning at a road construction work zone.

### BACKGROUND

Personnel at a road construction work zone are often required to work relatively close to moving traffic. As such, personnel must rely on driver compliance with speed limits and careful driving to avoid accidents causing injury or death.

### SUMMARY

As discussed below, a system and method are set forth for traffic warning at a road construction work zone. In one aspect, a motion sensor is associated with least one traffic cone in communication with a portable alert unit for warning a user of oncoming traffic.

In an aspect, a system is provided for traffic warning at a road construction work zone, comprising at least one a motion sensor associated with at least one traffic cone proximate the road construction work zone for transmitting laser pulses in a direction of oncoming traffic and detecting reflected laser pulses from the oncoming traffic and in response transmitting an alert signal; and a portable alert unit for receiving the alert signal and generating a warning of the oncoming traffic.

In another aspect, a method is set forth, comprising pairing the portable alert unit and at least one motion sensor, activating the at least one motion sensor to transmit laser pulses in a direction defined by a lens, receiving the reflected laser pulse from the oncoming traffic, calculating distance of the oncoming traffic, transmitting an alert to the portable alert unit, and generating an alarm of the oncoming traffic at the portable alert unit.

### BRIEF DESCRIPTION OF THE DRAWING FIGURES

The subject matter of the present disclosure is particularly pointed out and distinctly claimed in the concluding portion of the specification. A more complete understanding of the present disclosure, however, may best be obtained by referring to the detailed description when considered in connection with the drawing figures, wherein like numerals denote like elements and wherein:

FIG. 1 is a schematic illustration of a road construction work zone.

FIG. 2 is a schematic illustration depicting a motion sensor associated with a traffic cone in communication with a portable alert unit, according to an embodiment.

FIG. 3 is a schematic illustration depicting a portable alert unit, in accordance with an embodiment.

FIG. 4 is a schematic illustration depicting a motion sensor, in accordance with an embodiment.

FIG. 5 is a block diagram showing internal components of the portable alert unit of FIG. 3.

FIG. 6 is a block diagram showing internal components of the motion sensor of FIG. 4.

FIG. 7 is a flowchart showing operation of the motion sensor of FIG. 4 and portable alert unit of FIG. 3, according to an embodiment.

It will be appreciated that elements in the figures are illustrated for simplicity and clarity and have not necessarily been drawn to scale. For example, the dimensions of some of the elements in the figures may be exaggerated relative to other elements to help to improve understanding of illustrated embodiments of the present disclosure.

### DETAILED DESCRIPTION OF EXEMPLARY EMBODIMENTS

The description of exemplary embodiments of the present disclosure provided below is merely exemplary and is intended for purposes of illustration only; the following description is not intended to limit the scope of the invention disclosed herein. Moreover, recitation of multiple embodiments having stated features is not intended to exclude other embodiments having additional features or other embodiments incorporating different combinations of the stated features.

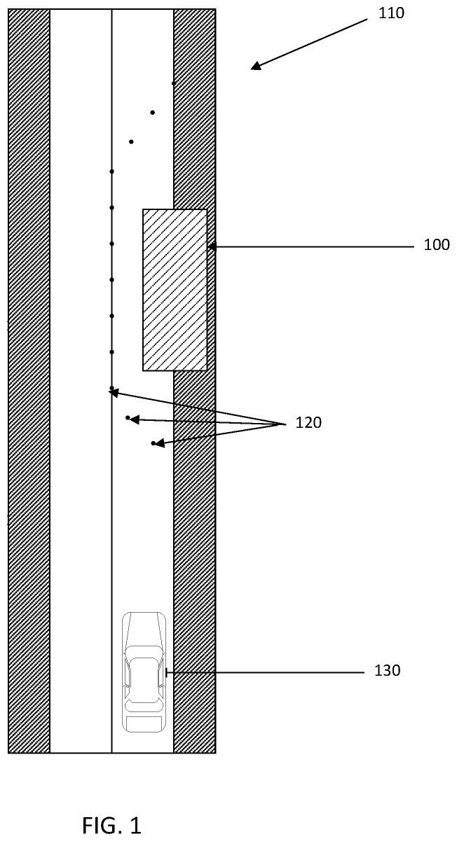

Turning to FIG. 1, a road construction work zone 100 is depicted for a roadway 110, around which traffic must divert. Traffic cones 120 are positioned to guide oncoming traffic 130 around the work zone 100. As discussed above, personnel working within the road construction work zone 100 must rely on driver compliance with speed limits and careful driving to avoid accidents causing injury or death.

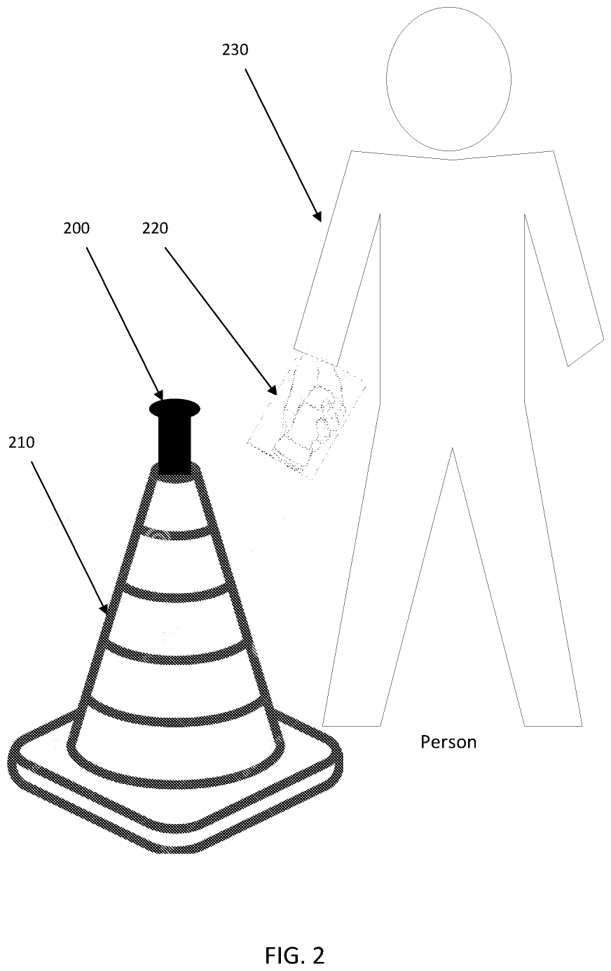

A system is shown in FIG. 2 for warning personnel of oncoming traffic, according to an embodiment. In one aspect, a motion sensor 200 is associated with at least one traffic cone 210 and communicates with a portable alert unit 220 for warning a user 230 of oncoming traffic.

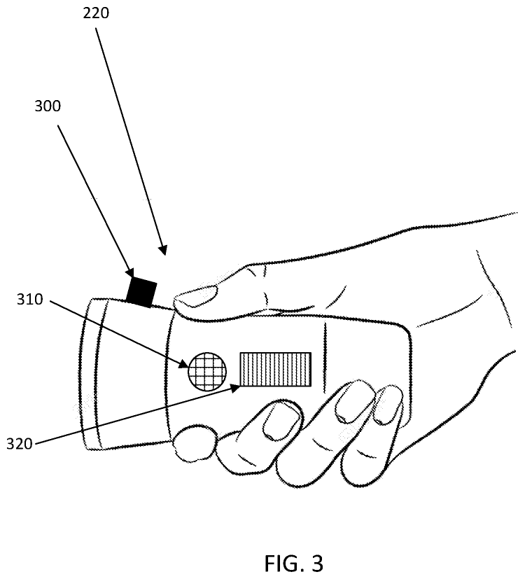

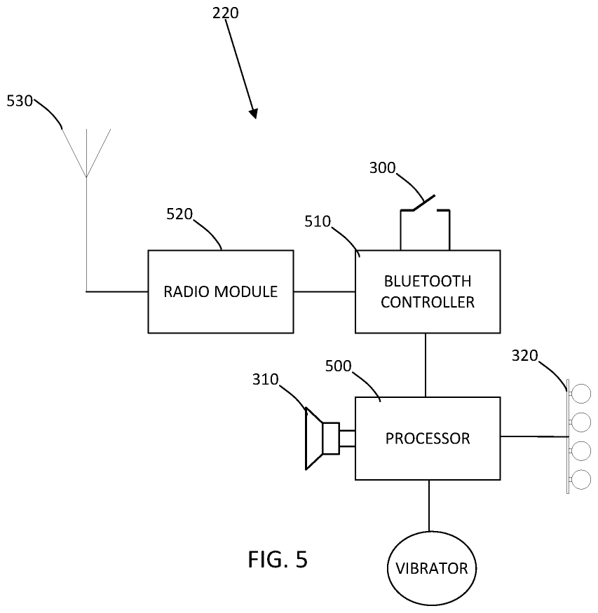

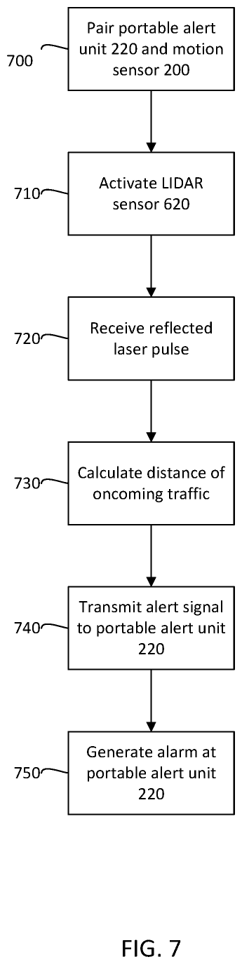

As shown in FIG. 3, the portable alert unit 220 may include an actuator 300 (e.g. a button) for activating initiation of communication with a motion sensor 200, a speaker 310 for broadcasting an audio warning signal and one or more lights 320 indicating operating status of the portable alert unit 220. Internal components the portable alert unit 220 are discussed below with reference to FIGS. 5 and 7.

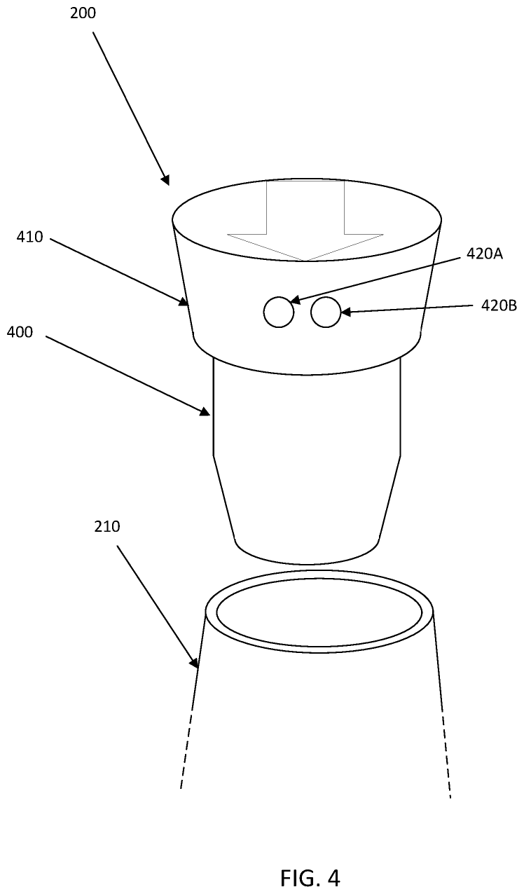

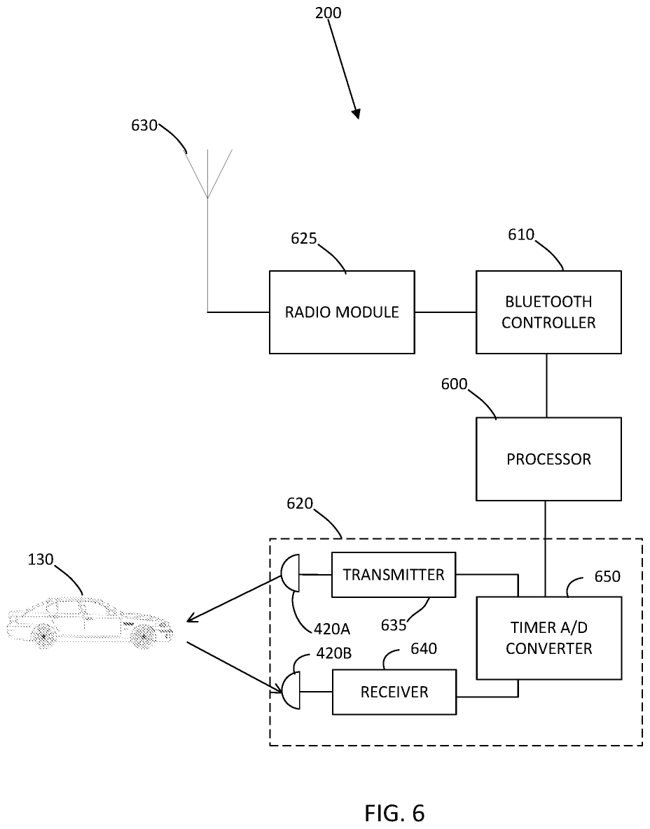

As shown in FIG. 4, motion sensor 200 is shaped to fit into an opening (e.g. a top circular hole) in the traffic cone 210. In an embodiment, the motion sensor 200 includes a tapered body portion 400 adapted to fit into the opening and a head portion 410 that forms a “plug” for the opening. The motion sensor 200 includes a transmitting lens 420A and receiving lens 420B, and additional internal components discussed below with reference to FIGS. 6 and 7.

Turning to FIG. 5, internal components of an exemplary portable alert unit 220 are shown including a processor 500 connected to a packet radio controller 510, speaker 310 lights 320 and a vibrator/shaker 330 for causing the unit 220 to vibrate. In an embodiment, lights 320 can include a multi-colour LED display. Packet radio controller 510 is activated by a switch 300 for initiating communication with the motion sensor 200 via radio module 520 (e.g. a 2.4 GHz radio module) and antenna 530.

Turning to FIG.6, internal components of an exemplary motion sensor 200 are shown including a processor 600 connected to a LIDAR (Light Detection and Ranging) sensor 620 and a radio module 625 having an antenna 630. In an embodiment, LIDAR sensor 620 comprises a transmitter 635, which can be a laser diode, a receiver 640, which can be a photodiode, transmitting lens 420A, receiving lens 420B, and a timer and analog-to-digital (A/D) converter 650.

In an embodiment, radio modules 520 and 625 are Class 1 radios having a range of up to 100 metres (300 ft) at 20 dBm and 100 mW. Because the devices communicate via radio signals, the portable alert unit 220 and motion sensor 200 do not need to be in visual line of sight of each other. In other embodiments, LoRa (Long Range) or other suitable low-power wide-area network modulation techniques may be used for communication between the portable alert unit 220 and motion sensor 200.

In operation, a user 230 activates the portable alert unit 220 by pressing button 300. This initiates a pairing process between the portable alert unit 220 and motion sensor 200 (700 in FIG. 7), wherein the radio modules 520 and 625 share addresses, names and profiles according to an authentication process, as is known in the art. Upon completion of pairing, portable alert unit 220 may cause lights 320 to be illuminated (e.g. flashing green lights).

Next, at 710, processor 600 of motion sensor 200 activates the LIDAR sensor 620 causing the transmitter 635 to emit laser pulses in a direction defined by lens 420A. As shown in FIG. 4, the head portion 410 of motion sensor 200 may include indicia, such as an arrow, indicating the direction of the laser beam (i.e. to assist placement of the motion sensor 200 for detecting oncoming traffic 130). In the event of oncoming traffic 130, the laser pulses are reflected and received by lens 420B and receiver 640 (step 720). Timer and A/D converter 650 calculates the amount of time that each transmitted pulse is reflected back to receiver 640 to calculate the distance between the oncoming traffic 130 and motion sensor 200 in traffic cone 210 (step 730). This timing information is transmitted to processor 600 and in the event that the distance is less than a chosen threshold (e.g. 300 ft) an alert signal is transmitted from motion sensor 200 to the portable alert unit 220 via the radio connection (step 740). In response to receiving the alert signal, processor 500 of portable alert unit 220 generates a suitable alarm (step 750), such as one or more of an audio alert via speaker 310, flashing red lights 320, and internal vibration via vibrator/shaker 330.

Upon being alerted to oncoming traffic 130, the user (e.g. worker) can take appropriate protective measures such as departing safely from the work zone 100.

Alternatives and modifications are contemplated. For example, rather than using a single motion sensor 200, a relay of sensors may be provided using a gateway wherein the alert signal is transmitted from one sensor to an adjacent sensor for further extending the range of operation of the traffic warning system.

It is also contemplated that, rather than using a single LIDAR sensor 620, multiple such sensors may be incorporated into the motion sensor 200 and aimed via associated lenses in additional directions (e.g. rear view, side views, etc.)

The present invention has been described above with reference to a number of exemplary embodiments and examples. It should be appreciated that the particular embodiments shown and described herein are illustrative of the invention and its best mode and are not intended to limit in any way the scope of the invention as set forth in the claims. The features of the various embodiments may stand alone or be combined in any combination. Further, unless otherwise noted, various illustrated steps of a method can be performed sequentially or at the same time, and not necessarily be performed in the order illustrated. It will be recognized that changes and modifications may be made to the exemplary embodiments without departing from the scope of the present invention. For example, although much of the disclosure relates to verifying a recorded audio communication between two or more devices, exemplary systems and methods can be used for other applications, such as determining a context of a recording from a relatively small sample of the recording. These and other changes or modifications are intended to be included within the scope of the present invention, as expressed in the following claims.

1. A system for traffic warning at a road construction work zone, comprising:
at least one a motion sensor associated with at least one traffic cone proximate the road construction work zone for transmitting laser pulses in a direction of oncoming traffic and detecting reflected laser pulses from the oncoming traffic and in response transmitting an alert signal; and
a portable alert unit for receiving the alert signal and generating a warning of the oncoming traffic.

2. The system of claim 1, wherein the at least one a motion sensor transmits said alert signal to the portable alert unit using radio communication.

3. The system of claim 2, wherein the radio communication is via long range low-power wide-area network modulation and/or Class 1 radio.

4. The system of claim 1, wherein the portable alert unit includes at least one of a speaker, lights and internal vibrator/shaker for generating said warning.

5. The system of claim 1, wherein the at least one a motion sensor includes a LIDAR (Light Detection and Ranging) sensor for detecting oncoming traffic.

6. The system of claim 1, wherein the portable alert unit includes an actuator for activating initiation of communication with the at least one motion sensor.

7. The system of claim 1, wherein the motion sensor is shaped to fit into an opening in the traffic cone.

8. The system of claim 7, wherein the motion sensor includes a tapered body portion adapted to fit into the opening and a head portion that forms a plug for the opening.

9. The system of claim 8, wherein the head portion includes indicia indicating direction of the transmitted laser beam to assist placement of the at least one motion sensor for detecting the oncoming traffic.

10. The system of claim 1, wherein the portable alert unit includes a processor connected to a packet radio controller and at least one of a speaker, lights and a vibrator/shaker for causing the portable alert unit to vibrate.

11. The system of claim 10, wherein the packet radio controller is activated by a switch for initiating communication with the motion sensor via a radio module and antenna.

12. The system of claim 10, wherein the lights comprise a multi-colour LED display.

13. The system of claim 1, wherein the motion sensor includes a processor connected to a LIDAR (Light Detection and Ranging) sensor and a radio module having an antenna.

14. The system of claim 1, wherein the LIDAR sensor comprises a transmitter, which can be a laser diode, a receiver, which can be a photodiode, a transmitting lens, a receiving lens, and a timer and analog-to-digital (A/D) converter.

15. The system of claim 1, wherein the LIDAR sensor comprises a transmitter for transmitting the laser pulses, a transmitting lens for directing the laser pulse toward the oncoming traffic, a receiver and a receiving lens for detecting the reflected laser pulses from the direction of the oncoming traffic.

16. The system of claim 15, wherein the transmitter comprises a laser diode.

17. The system of claim 15, wherein the receiver comprises a photodiode.

18. The system of claim 1, wherein the LIDAR sensor includes a timer and analog-to-digital (A/D) converter for calculating the amount of time that each transmitted laser pulse is reflected back to the receiver to calculate the distance between the oncoming traffic and the at least one motion sensor.

19. A method of operating the system of claim 1, comprising:
pairing the portable alert unit and at least one motion sensor;
activating the at least one motion sensor to transmit laser pulses in a direction defined by a lens;
receiving the reflected laser pulse from the oncoming traffic;
calculating distance of the oncoming traffic;
transmitting an alert to the portable alert unit; and
generating an alarm of the oncoming traffic at the portable alert unit.

20. The method of claim 14, wherein calculating distance of the oncoming traffic comprises calculating the amount of time that each transmitted laser pulse is reflected back from the oncoming traffic and calculating therefrom the distance between the oncoming traffic and the at least one motion sensor.

21. The method of claim 20, wherein the alert is transmitted to the portable alert unit in the event that the distance is less than a threshold.
